(19) United States
(12) Patent Application Publication
(10) Pub. No.: US 2003/0144925 A1
(43) Pub. Date: Jul. 31, 2003

(54) Method for saving abandoned shopping carts using an e-mail launched web transaction

(76) Inventor: Jeffrey Douglas Greenberg, Delaplane, VA (US)

Correspondence Address: PIPER RUDNICK LLP, Supervisor, Patent Prosecution Services, 1200 Nineteenth Street, N.W., Washington, DC, 20036-2412, US

(21) Appl. No.: 10/190,658

(22) Filed: Jul. 9, 2002

Related U.S. Application Data
(63) Continuation-in-part of application No. 10/059,348, filed on Jan. 31, 2002.

(51) Int. Cl. G06F 17/60

(52) U.S. Cl. 705/27

(57) ABSTRACT

A method and computer program product to streamline electronic commerce transactions using an e-mail launched Web transaction process is provided. An e-mail is sent to a prospective customer which includes an offer for sale, fields in which shipping and billing information may be entered, and a button which may be activated to accept the offer. Upon activation of the button, a secure communications channel is established between the customer's Web browser and a transaction server. The acceptance is sent via the secure channel and a confirmation of the offer is then returned to the customer. The saving of abandoned shopping carts using such an e-mail launched Web transaction process is also provided. This allows abandoned shopping carts to be converted into actual revenue by eliminating the need to re-visit a merchant's Web site, replace goods or services in a shopping cart and having to go through the checkout process.

This application claims priority from, and is a continuation-in-part application of, U.S. patent application Ser. No. 10/059,348, filed on Jan. 31, 2002. The entirety of that application is incorporated herein by reference.

### BACKGROUND OF THE INVENTION

1. Field of the Invention

The invention generally relates to electronic transactions, and more particularly to methods for preserving and completing abandoned commercial transactions using electronic mail messages.

2. Related Art

In today's economy, electronic commerce is becoming a larger percentage of sales revenues for both traditional “bricks and mortar” merchants and electronic retailers (i.e., “e-tailers”). Such revenue is derived from the sales of good and services directly to consumers over the public, global Internet (and World Wide Web).

It is well known among traditional merchants attempting to boost sales by doing business over the Internet and e-tailers (collectively, “Internet merchants”) that the amount of time, mouse “clicks” and Web pages required for a consumer to complete a purchase over the Internet has a direct and dramatic effect on sales. Therefore, much effort has been expended in minimizing the amount of time and number of actions required for a consumer to make an Internet purchase. For example, U.S. Pat. No. 5,960,411 (“the '411 patent”), is directed to a method and system that allows an Internet purchase to be made with a single click of a user's mouse. While the '411 patent somewhat streamlines the purchasing process, it still suffers from the drawback that a user must first locate the desired item in order to place an, order for it and thus does not streamline the purchase process to the fullest extent possible.

It is also well known among Internet merchants that sending electronic mail (e-mail) messages to customers that include links to specific merchant Web sites can be effective. While such e-mails direct traffic and provide a shortcut to a merchant's Web site, the user must click on the link to visit the merchant's Web site and then must still perform further actions in order to initiate and complete the transaction.

It is common for many merchant sites to employ an electronic shopping basket where visitors to the site (i.e., consumers) may view items and place those they wish to purchase before they “checkout.” The checkout process generally involves the consumer entering billing information, shipping information and certain preferences in order to complete the transaction and receive the good(s) and/or service(s) purchased. Consequently, another problem faced by Internet merchants is what is known as “shopping cart abandonment.” This results when online shoppers choose not to buy the items they have placed in their online shopping baskets (i.e., they fail to checkout).

It has been (conservatively) estimated that at least 25% of all shopping carts are abandoned by online shoppers. Reasons for shopping cart abandonment are varied and include high shipping cost which is not typically shown until checkout, the checkout process taking too long, shoppers changing their minds about purchasing the selected good(s) and/or service(s), or simply a Web site whose poor design makes it difficult to complete the checkout process. In response, Internet merchants have attempted to improve the design of their Web sites, utilize faster Web servers and offer live customer service support. These solutions, however, have failed to convert many of these abandoned shopping carts into actual sales revenue for Internet merchants.

Given the above, what is needed is an e-mail launched Web transaction process that streamlines and further minimizes the amount of time and effort required to initiate and complete electronic commerce transactions. Further, what is needed is a method for saving abandoned shopping carts using such e-mail launched Web transactions.

### SUMMARY OF THE INVENTION

The present invention meets the aforementioned needs by providing a method and computer program product for creating an electronic mail message (“e-mail”) that includes a description of a proposed transaction (e.g., a description of goods for sale along with a price for the goods) and then sent to a consumer. Once the e-mail is received and opened by the consumer, they are provided with the ability to initiate and complete the transaction by activating a button found within the e-mail without the need to actually visit the merchant's Web site. The transaction is preferably using a secure channel technology such as Secure Socket Layer (SSL) or Transport Layer Security (TLS). In one embodiment, the secure channel is established by spawning a browser window and utilizing support for secure channels that is built into the consumer's browser.

In an embodiment of the present invention, a method and computer program product for saving abandoned shopping carts using such e-mail launched Web transactions is provided. More specifically, an e-mail would include a description the good(s) and/or service(s) contained in a shopping cart previously abandoned by the consumer. Once the e-mail is received and opened by the consumer, they are provided with the ability to initiate and complete the abandoned transaction by activating a button found within the e-mail without the need to re-visit the merchant's Web site, replace those good(s) and/or service(s) in their shopping cart and then going through the checkout process.

An advantage of the present invention is that streamlines electronic commerce transaction by allowing consumers to purchase good(s) and/or service(s) by simply receiving an e-mail and activating a button found within the email, all without the need to visit a merchant's Web site.

Another advantage of the present invention is that it allows Internet merchants to convert abandoned shopping carts into actual sales revenue.

Further features and advantages of the invention as well as the structure and operation of various embodiments of the present invention are described in detail below with reference to the accompanying drawings.

### DESCRIPTION OF THE INVENTION

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

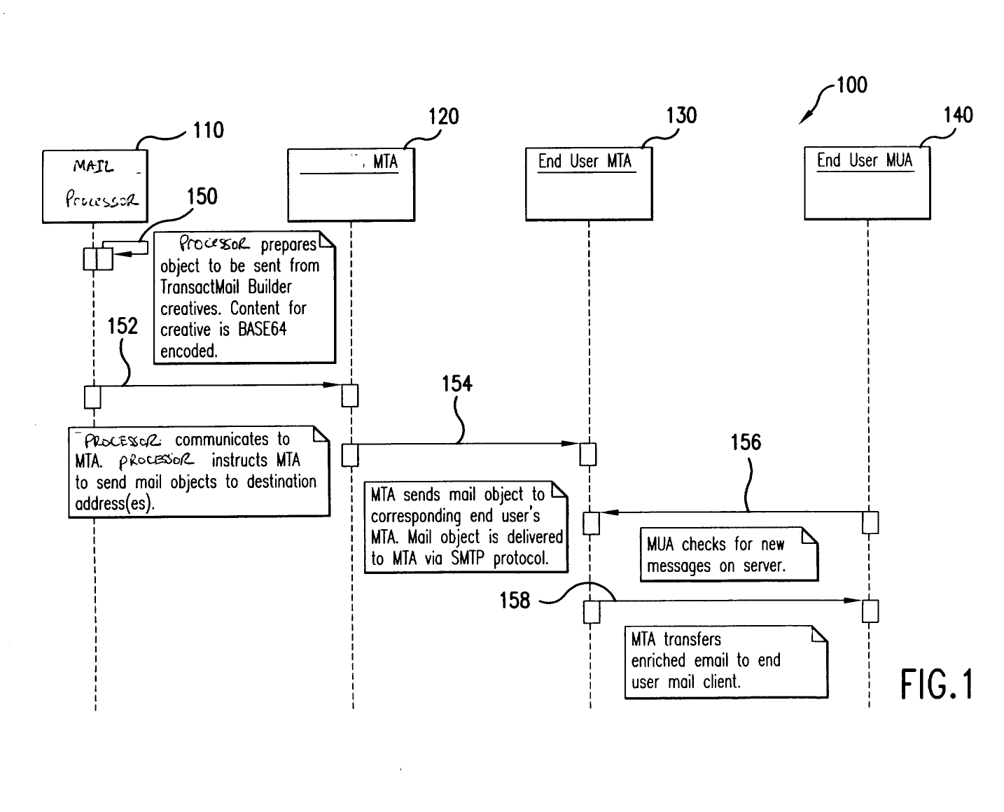

FIG. 1 is a sequence diagram showing an e-mail creation and transfer process according to an embodiment of the present invention.

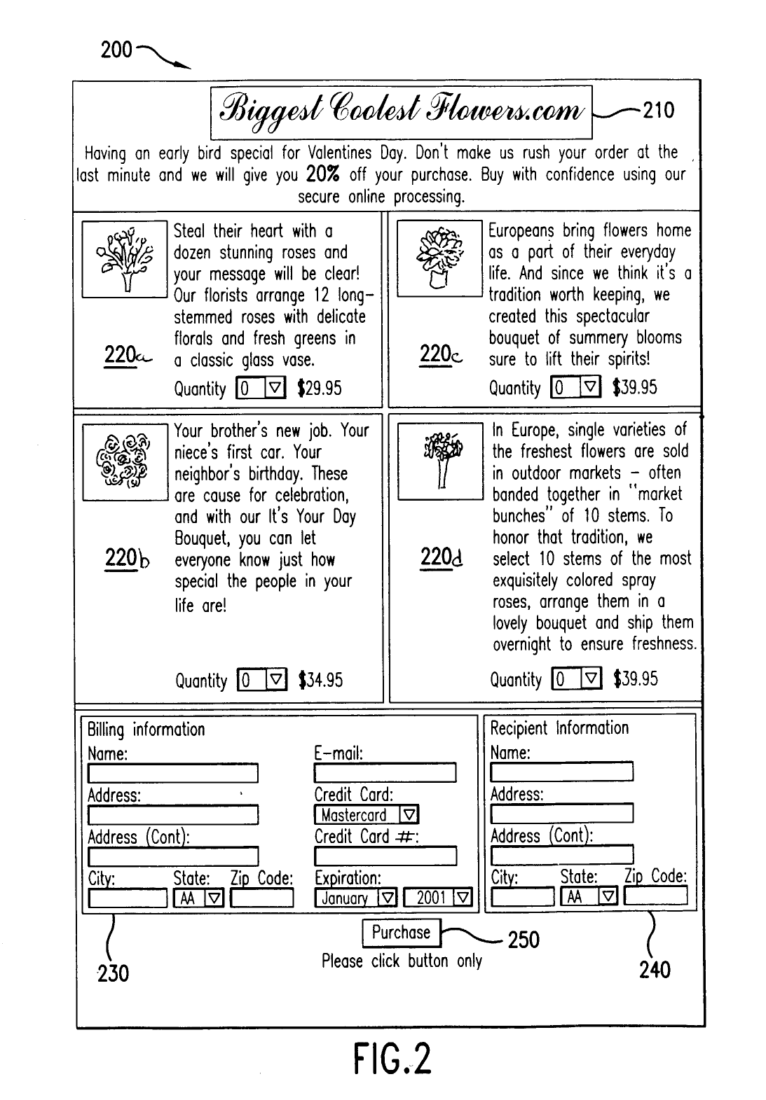

FIG. 2 is a window or screen shot showing an exemplary e-mail created during the e-mail creation and transfer process of FIG. 1.

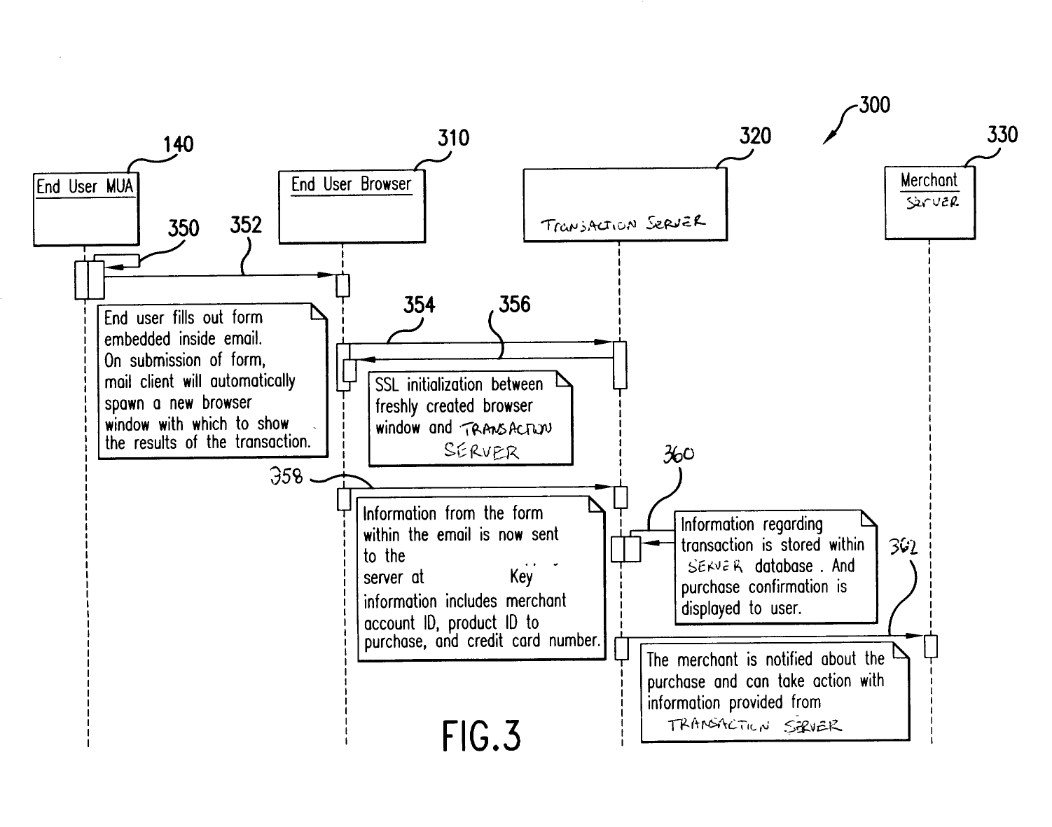

FIG. 3 is a sequence diagram showing an e-mail launched web transaction process, utilizing the e-mail of FIG. 2, according to an embodiment of the present invention.

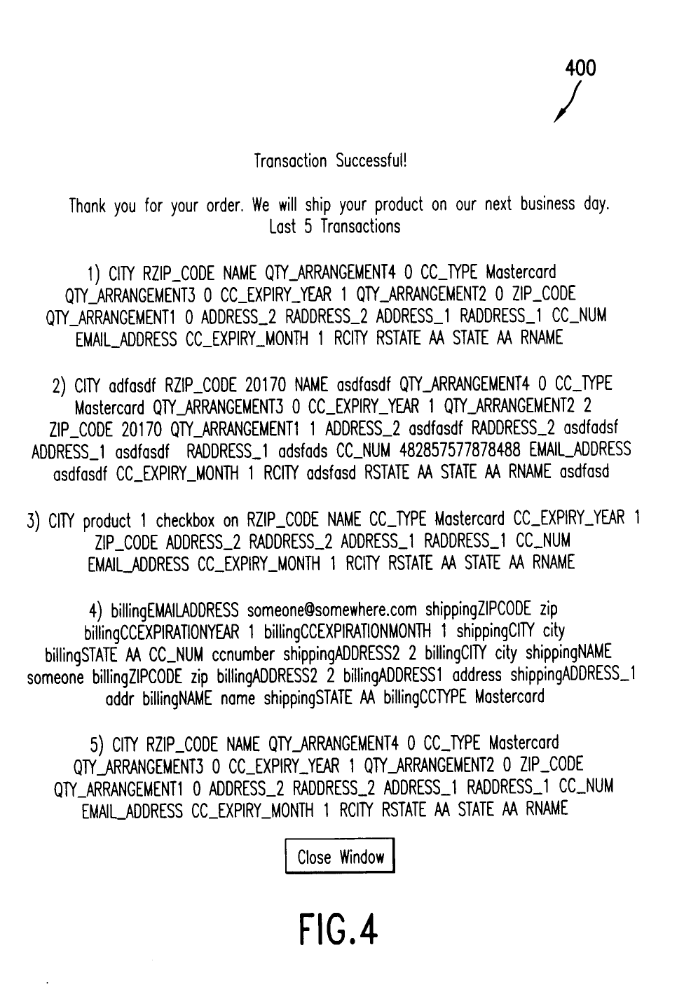

FIG. 4 is a window or screen shot, according to an embodiment of the present invention, of a confirmation of the transaction initiated from the e-mail of FIG. 2.

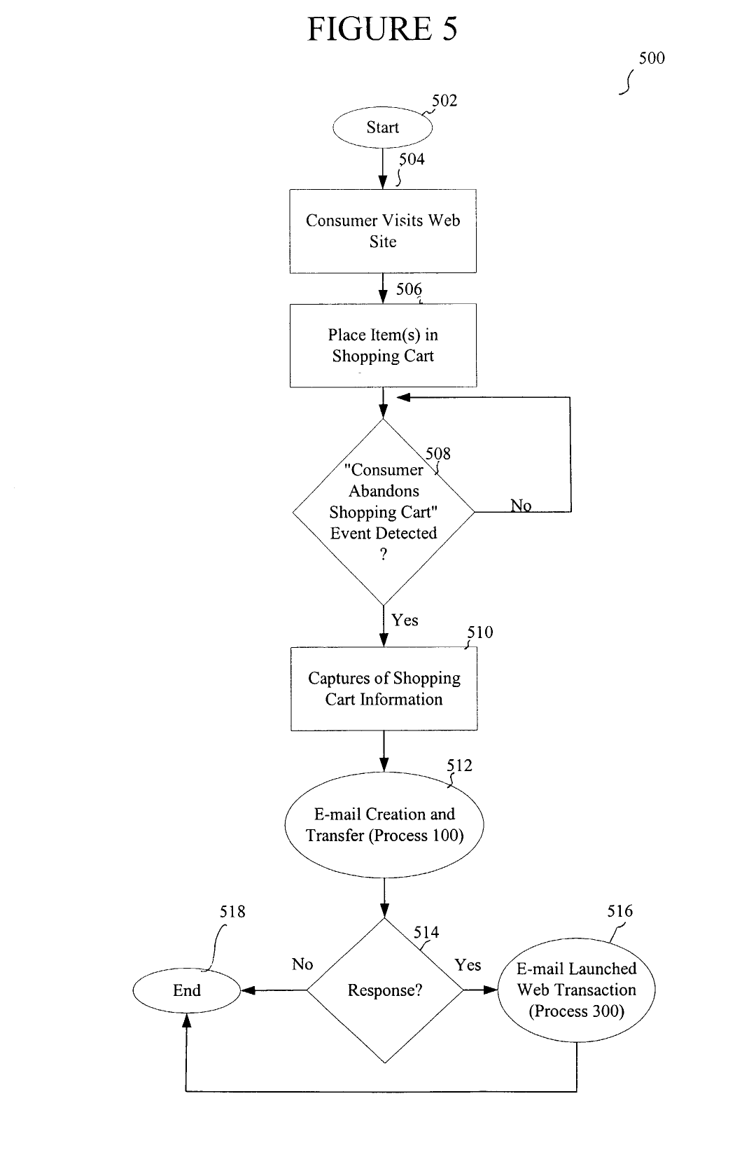

FIG. 5 is a flowchart illustrating an abandoned shopping cart saver process according to an embodiment of the present invention.

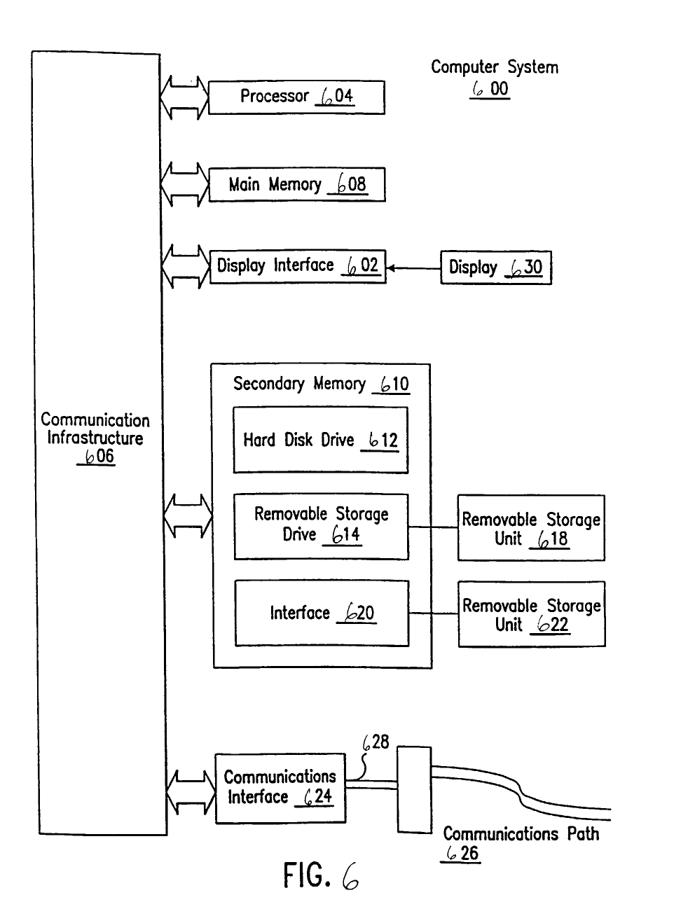

FIG. 6 is a block diagram of an exemplary computer system useful for implementing the present invention.

### DESCRIPTION

I. Overview

The present invention relates to e-mail launched Web transaction processes that streamline electronic commerce transactions and a method and computer program product for saving abandoned shopping carts using such e-mail launched Web transactions.

In an embodiment of the present invention, an Internet merchant (or a marketing entity or service provider hired by an Internet merchant) selling particular good(s) and/or service(s) will initiate electronic commerce transactions from electronic mail (“e-mail”) messages. The merchant (or marketing entity) would provide the hardware (e.g., Web servers and electronic mail severs) and software (e.g., databases) infrastructure, application software, customer support, and billing mechanism to allow it to send such e-mail messages to consumers and complete the contemplated commercial transactions.

The present invention is described in terms of the above example. This is for convenience only and is not intended to limit the application of the present invention. In fact, after reading the following description, it will be apparent to one skilled in the relevant art(s) how to implement the following invention in alternative embodiments.

For ease of understanding, certain method steps are delineated as separate steps; however, these steps should not be construed as necessarily distinct, nor order dependent in their performance. Specific details, such as types of transactions, types of data required for transactions, etc., are provided in order to provide a thorough understanding of the invention. The preferred embodiments discussed herein should not be understood to limit the invention.

The terms “end user,” “consumer,” “shopper,” “customer,” and the plural form of these terms are used interchangeably throughout herein to refer to those who would access, use, and/or benefit from the tool that the present invention provides for saving abandoned shopping carts using e-mail launched Web transactions.

II. E-Mail Launched Web Transaction Process

Referring to FIG. 1, an e-mail creation and transfer process 100, according to an embodiment of the present invention, is shown. Process 100 (i.e., sequence of steps 150-158) begins at step 150, where an electronic mail message object is composed at a processor 110. (An exemplary electronic mail message 200 is shown in FIG. 2 and is described in more detail below.) In an embodiment of the present invention, e-mail 200 is composed using the Hyper Text Markup Language (HTML) in a manner that is well known in the relevant art(s). In an alternate embodiment, Base 64 encoding is used in order to transmit any underlying (binary) encoding that forms e-mail 200 through certain text-only electronic mail systems.

After e-mail 200 has been composed, processor 110 transmits e-mail 200 to a mail transfer agent (i.e., an e-mail server) 120 along with the delivery destination(s) (i.e., e-mail addresses) at step 152. The mail transfer agent (MTA) 120 then sends e-mail 200 to the specified destination(s), including at least one end user mail transfer agent 130 at step 154. In an embodiment of the present invention, step 154 is accomplished using the Simple Mail Transfer Protocol (SMTP). E-mail 200 is then stored at end user mail transfer agent 130 until the end user's mail user agent 140 (e.g., Microsoft® Outlook® Express or the like) checks for new messages at step 156. Then, e-mail 200 is sent from end user mail transfer agent 130 to end user mail user agent (MUA) 140, where it is viewed by the customer at step 158.

Referring to FIG. 2, an electronic mail message object (or simply, “e-mail”) 200, according to an embodiment of the present invention, is shown. E-mail 200, which in this example, flowers are offered for sale, includes a field 210 that displays the name of the merchant. A plurality of fields 220 display the good(s) and/or service(s) being offered for sale. E-mail 200, in this example, includes four different flower arrangements (i.e., fields 220a-d) being offered for sale. In preferred embodiments of the invention, the number of different good(s) and/or service(s) is kept small (e.g., 1 to 5), although the inclusion of a larger numbers of good(s) and/or service(s) are also within the purview of the invention.

E-mail 200 also includes a billing information area 230 into which a consumer receiving the e-mail may enter billing information such as name, address, and credit card information. E-mail 200 further includes a recipient information area 240, which may be used to enter shipping information in the event that it is different from the billing information. Finally, e-mail 200 includes a Purchase “button” 250, which the consumer may press to accept the offer and complete the transaction contemplated by e-mail 200. (As used herein, the term “button” is used in a generic sense and should be understood to refer to any input mechanism, now known or later developed, by which a customer can indicate a desire to accept a proposed offer and thus, complete a commercial transaction.)

Referring to FIG. 3, an e-mail launched web transaction process 300, according to an embodiment of the present invention, is shown. Process 300 (i.e., sequence of steps 350-362) begins when a consumer/e-mail recipient views e-mail 200 and decides to purchase any of the offered good(s) and/or service(s).

In step 350, the consumer enters any required information (e.g., name, address and credit card number) in billing information area 230, any required shipping information in shipping information area 240, and any other required/desired information (e.g., quantity of items ordered, etc.).

In step 352, when the consumer clicks or otherwise activates Purchase button 250, mail user agent 140 spawns a new browser window 310 (which in a preferred embodiment, is visible to the consumer). The spawning of new browser window 310 includes a HyperText Transmission Protocol, Secure (HTTPS) Uniform Resource Locator (URL) request for a secure transaction server 320.

As a result of step 352, browser window 310 initiates SSL handshaking and certificate exchange with transaction server 320 at steps 354 and 356. A secure communications channel is thereby established. In step 358, once the secure communications channel has been established, the information previously entered by the customer in step 350 is sent from browser window 310 to transaction server 320.

In step 360, transaction server 320 then stores the transaction in a database located on, or accessible to, server 320. Next, a confirmation 400 (shown in FIG. 4) of the transaction is downloaded to browser window 310. Finally, at step 362, merchant server 330 is notified of the transaction and takes the appropriate action to execute the transaction for the purchased good(s) and/or service(s) based on the (billing and shipping) information previously provided by the customer in step 350.

It should be understood that the screens shown herein for e-mail 200 and confirmation 400, which highlight the functionality of the present invention, are presented for example purposes only. The present invention is sufficiently flexible and configurable such that consumers may receive e-mails or see displayed windows other than the ones shown in FIG. 2 and FIG. 4.

In the embodiment of FIG. 3 discussed above, transaction server 320 and merchant server 330 are illustrated as separate physical components. Such an arrangement allows for a marketing entity (or service provider) to act as a “middle man” between consumers and merchants selling good(s) and/or service(s). In such an embodiment, the need for any modification to the merchant's Web site to implement the present invention is eliminated. Further, this provides the opportunity for a fee to be collected by the service provider for all transactions forwarded to merchant server 330. Such a fee might be collected as a result of the service provider having prepared and/or sent e-mail 200. In other embodiments, where the merchant directly implements the present invention, browser window 310 communicates directly with the merchant server 330, thereby “cutting out the middle man” (i.e., server 320).

In alternate embodiments, the functions of other components shown as separate, may be performed by the same physical device. For example, the functions performed by mail transfer agent 120 and transaction server 320 may be performed by a single server. Those of skill in the art will recognize that other combinations of functions are similarly possible.

As mentioned above, new browser window 310 is visible to the consumer when it is spawned in step 352. One of the reasons new browser window 310 is opened is to take advantage of the built-in support for SSL/TLS secure channels provided by most current browsers such as Microsoft® Internet Explorer, Netscape® Navigator and the like. This is done because most current mail user agents 140 (e.g., Microsoft® Outlook®, Eudora® and the like) do not support such secure channels although they support the display of HTML documents.

In an alternate embodiment of the present invention, new browser window 310 is hidden from the recipient. In such an embodiment, confirmation of the transaction could be provided by way of a separate e-mail from transaction server 320 (or merchant server 330) to mail user agent 140, rather than through the download of a confirmation Web page 400 to new browser window 310. The need for new browser window 310, however, may be eliminated entirely if mail user agent 140 is equipped to support secure channel communications.

From the point of view of the consumer, with the exception of entering the information discussed above in connection with step 350, which is done “in the e-mail” (i.e., the consumer enters the information in the same window in which e-mail 200 is displayed by mail user agent 140), the entire transaction is completed with a single click or activation of Purchase button 250. There is no need for the consumer to actually visit a merchant's Web site. Further, prior to viewing e-mail 200 and activating Purchase button 250, there is no need for the consumer to even open a browser window. Thus, the process of the present invention facilitates the online ordering of a desired good or service in comparison to known methods.

In the embodiment illustrated in FIGS. 1-4, consumers are required to enter identification information such as name and address. In alternate embodiments, where individualized e-mails are sent to targeted consumers (e.g., from an e-mail list purchased by the merchant from a third-party, or a database of the merchant's existing customers), the information in areas 230 and 240 may be pre-populated (i.e., inserted into the e-mail in advance). Such an alternate embodiment is described in Section III below.

In yet other embodiments of the present invention, e-mails sent to a merchant's existing customers may include a customer identification (ID) code which is transmitted to transaction server 320 when a “Purchase Using Default Options” button is activated within e-mail 200. In such embodiments, only the customer ID code is sent to the merchant because they already possesses the billing and shipping information needed to complete the transaction. If the default information is correct, the entire transaction may be completed with one simple click. The e-mails in such an embodiment may also provide the customer with the opportunity to modify the default (e.g., shipping) information.

III. Abandoned Shopping Cart Saver Process

As mentioned above, embodiments of the present invention include those where individualized e-mails are sent to targeted consumers and thus, the information in areas 230 and 240 of e-mail 200 may be pre-populated before being sent such consumers. That is, a method for saving abandoned shopping carts using e-mail creation and transfer process 100 and e-mail launched Web transactions process 300 described above is now described.

Referring to FIG. 5, a flowchart illustrating an abandoned shopping cart saver process 500, according to an embodiment of the present invention, is shown. Process 500, which allows Internet merchants to convert abandoned shopping carts into actual sales revenue, begins in step 502 with control passing immediately to step 504.

In step 504, a consumer visits a merchant's Web site with the intention of browsing (and possibly, purchasing) good(s) and/or service(s) offered by the merchant. In step 506, the online shopper places any number of items (i.e., any offered goods or services) they wish to purchase in an electronic shopping cart as is well known by those skilled in the relevant art(s).

In step 508, process 500 executing on, for example, sever 320 (or server 330), loops until it detects a “consumer shopping cart abandonment” event. Such an event is detected when the online shopper, for example, closes their browser (i.e., clicks the x-in-a-box “ [symbol] ” icon in the upper right-hand corner of the browser window) before checking out. In an alternate embodiment, such an event is detected when the shopper, via their browser, initiates a URL request which is not part of the merchant's Web site (i.e., the consumer surfs to another Web site). In either event, this indicates that the online shopper choose not to complete the transaction (i.e., buy) the item(s) placed in their shopping cart due to high shipping cost, the checkout process taking too long, a change of mind or a Web site whose poor design makes it difficult to checkout.

In step 510, after detecting a “consumer shopping cart abandonment” event, a window is spawned (which, like window 310, may or may not be visible to the consumer) which causes all the information entered by the consumer (i.e., any billing information, shipping information, items placed in the shopping cart, etc.) to be sent via a pipe to an abandonment database located on, or accessible to, server 320 or 330.

In step 512, the sequence of steps of e-mail creation and transfer process 100 is performed, where an electronic mail message object 200 is created, the data fields (i.e., fields 220 and fields within areas 230 and 240) are pre-populated using the information entered by the consumer that were previously stored in the abandonment database during step 510, and then sent to the consumer who abandoned the shopping cart.

In an embodiment of the present invention, the transition from step 510 to step 512 is accomplished using a Practical Extraction and Report Language (PERL) script which executes upon receiving each “consumer shopping cart abandonment” event in step 510. In an alternate embodiment, the transition is performed on a pre-determined, scheduled “batch” basis (e.g., once every five seconds, etc.).

In step 514, process 500 determines whether the consumer positively responds to the e-mail 200 sent to them in step 512. If not, process 500 ends as indicated by step 518. If so, process 500 proceeds to step 516.

In step 516, the sequence of steps of e-mail launched web transaction process 300 is performed. That is, once the e-mail is received and opened by the consumer, they are provided with the ability to initiate and complete the abandoned transaction by activating button 250 found within e-mail 200 without the need to re-visit the merchant's Web site, replace those good(s) and/or service(s) in their shopping cart and then going through the checkout process. Process 500 would then end as indicated by step 518.

As will be appreciated by one skilled in the relevant art(s) after reading the description herein, the success of process 500 in converting abandoned shopping carts into actual sales revenue relies on the merchant's Web site design to obtain each shopper's e-mail address early on during the shopper's visit to their Web site.

IV. Example Implementations

The present invention (i.e., processes 100, 300 and/or 500, and/or any part(s) or function(s) thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 600 is shown in FIG. 6. The computer system 600 includes one or more processors, such as processor 604. The processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which maybe electronic, electromagnetic, optical or other signals capable of being received by communications interface 624. These signals 628 are provided to communications interface 624 via a communications path (e.g., channel) 626. This channel 626 carries signals 628 and maybe implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

V. Conclusion

While various embodiments of the present invention have been described above, it should be understood that they have been presented by way of example and not limitation. It will be apparent to persons skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method for completing an electronic transaction from an abandoned shopping cart, said method comprising the steps of:
receiving, during a visit to a merchant Web site, an e-mail address from a consumer;
receiving an input indicative that said consumer desires to place at least one item offered on said merchant Web site in a shopping cart;
detecting an event indicative that said consumer has abandoned said shopping cart;
sending an email to said consumer, using said received e-mail address, said email including an offer reflective of the contents of said shopping cart and a button for indicating acceptance of the offer; and
receiving an indication that said button within said e-mail was activated, and executing a transaction for at least a portion of the contents of said shopping cart.

2. The method of claim 1, further comprising the step of sending, to said consumer's computer, a confirmation of receipt of said indication that said button within said e-mail was activated.

3. The method of claim 2, wherein said confirmation is sent to said consumer within a second e-mail.

4. The method of claim 1, wherein the step of executing said transaction, comprises the steps of:
spawning, at said consumer's computer, a browser window containing the contents of said email;
establishing a secure communications channel between said browser window and a transaction server; and
transmitting the contents of said browser window to said transaction server.

5. The method of claim 4, wherein said secure communications channel is a secure sockets layer (SSL) channel.

6. The method of claim 4, wherein said secure communications channel is a transport layer security (TLS) channel.

7. The method of claim 4, wherein said browser window is displayed to said consumer.

8. The method of claim 4, wherein said browser window is hidden from said consumer.

9. A computer program product comprising a computer usable medium having control logic stored therein for causing a computer to complete an electronic transaction from an abandoned shopping cart, said control logic comprising:
first computer readable program code means for causing the computer to receive, during a visit to a merchant Web site, an e-mail address from a consumer;
second computer readable program code means for causing the computer to receive an input indicative that said consumer desires to place at least one item offered on said merchant Web site in a shopping cart;
third computer readable program code means for causing the computer to detect an event indicative that said consumer has abandoned said shopping cart;
fourth computer readable program code means for causing the computer to send an email to said consumer, using said received e-mail address, said email including an offer reflective of the contents of said shopping cart and a button for indicating acceptance of the offer; and
fifth computer readable program code means for causing the computer to receive an indication that said button within said e-mail was activated, and execute a transaction for at least a portion of the contents of said shopping cart.

10. The computer program product of claim 9, further comprising:
sixth computer readable program code means for causing the computer to send, to said consumer's computer, a confirmation of receipt of said indication that said button within said e-mail was activated.

11. The computer program product of claim 10, wherein said confirmation is sent to said consumer within a second e-mail.

12. The computer program product of claim 9, wherein said fifth computer readable program code means for causing the computer to execute a transaction, comprises:
sixth computer readable program code means for causing the computer to spawn, at said consumer's computer, a browser window containing the contents of said email;
seventh computer readable program code means for causing the computer to establish a secure communications channel between said browser window and a transaction server; and
eighth computer readable program code means for causing the computer to transmit the contents of said browser window to said transaction server.
